(19) United States
(12) Patent Application Publication
(10) Pub. No.: US 2012/0210304 A1
(43) Pub. Date: Aug. 16, 2012

(54) PROGRAM RECONFIGURATION SYSTEM AND PROGRAM RECONFIGURATION METHOD

(75) Inventor: Yoshiharu Maeno, Tokyo (JP)

(73) Assignee: NEC CORPORATION, Tokyo (JP)

(21) Appl. No.: 13/383,136

(22) PCT Filed: Jun. 7, 2010
(86) PCT No.: PCT/JP2010/059634

§ 371 Date: May 1, 2012

(30) Foreign Application Priority Data
Jul. 8, 2009 (JP) 2009-161668

(51) Int. Cl. G06F 9/44

(52) U.S. Cl. 717/121

(57) ABSTRACT

Customized programs of dealing with a tenant individual condition is reconfigured into a single program, without degradation of performance. Specifically, a program reconfiguration system which reconfigures the programs of dealing with the tenant individual condition into the single program, includes: a program development section configured to correct a part of a program sequence configuring a base program to create a customized program; a customization management table control section configured to create and update a customization management table; a program sequence attribute registering section configured to register the program sequences configuring the base program; a customization record registering section configured to register correction performed in case of the creation of the customized program every program sequence; a tenant attribute registering section configured to register attribute data of a tenant on the customization management table; and a program sequence calculating section configured to determine a use location of a multiple deployment program sequence.

### TECHNICAL FIELD

The present invention is related to a program reconfiguration system, and more particularly, to a program reconfiguration system to reconfigure programs into a single program.

### BACKGROUND ART

An example of a system to support processing of changing a conventional application is disclosed in JP 2008-117067A (Patent Literature 1).

This conventional system is provided with an annotation detecting section, an input interface (I/F) converting section, an output interface converting section, a new model generating section, and a design model storage section. The annotation means data which defines each of elements of a program and is never deleted at the time of compiling unlike a comment.

The conventional system having such a configuration operates as follows. That is, the annotation detecting section identifies an individual situation, the input interface converting section changes an input interface, and the output interface converting section changes an output interface. The new model generating section generates a design model calling the changed interface, and stores the result in the design model storage section.

Another example of the conventional system to support processing of changing an application is disclosed in JP 2007-213487A (Patent Literature 2).

This conventional system is provided with a user interface control section, a class data analyzing section, an advice analyzing section, and an aspect generating section. In case of the aspect-oriented programming, the aspect means processing which is common to many classes like the log output. Common processing is implemented by incorporating an aspect into the application. The definition of specific processing of an aspect is called an advice.

The conventional system having such a configuration operates as follows. That is, the class data analyzing section generates candidate of a class and a method which define the aspect. The advice analyzing section generates a candidate of a data structure contained in the advice. The user interface control section displays these candidates and the user selects one candidate. Based on the result of the selection, the aspect generating section generates an aspect.

In such an aspect-oriented programming technique, at the time of deployment and execution of a program, by referring to a tenant identifier and by using a multiple deployment program which branches to a program sequence different every tenant, customized programs corresponding to the tenant individual conditions can be reconfigured in a single program.

When multiple deployments are executed, a framework program showing the logic to refer to the tenant identifier, and to branch to a program sequence different every tenant, is automatically inserted in an application program. Even if not specified in the application program, the program sequence different every tenant is executed.

### CITATION LIST

[Patent Literature 1]: JP 2008-117067A
[Patent Literature 2]: JP 2007-213487A

### SUMMARY OF THE INVENTION

In reconfiguration of program, if all of customized program sequences are reconfigured like the conventional technique, the performance sometimes degrades because the reference to the tenant identifier and the branch to it frequently occur.

An object of the present invention is to provide a program reconfiguration system which reconfigures programs corresponding to tenant individual conditions into a single program.

In a program reconfiguration system of the present invention, the reconfiguration is carried out such that as many tenants (or customized programs) as possible can be accommodated while the number of locations where multiple deployment programs are used is suppressed within a predetermined number.

The program reconfiguration system of the present invention determines a location where the multiple deployment program sequence is used, and the number of tenants which can be accommodated by the multiple deployment program sequence, and supports the reconfiguration of the program sequences.

The program reconfiguration system of the present invention configures programs of dealing with tenant individual conditions into a single program, and is provided with a program development section configured to correct a part of each of program sequences configuring a base program to create a customized program; a customization management table control section configured to create and update a customization management table; a program sequence attribute registering section configured to register each of the program sequences configuring the base program; a customization record registering section configured to register the correction, which is performed in the creation of the customized program, every program sequence; a tenant attribute registering section configured to register attribute data of each of the tenants on the customization management table; and a program sequence calculating section configured to determine a location where a multiple deployment program sequence is used.

A program reconfiguration method of the present invention is executed by a computer, and is provide with: creating a customized program by correcting a part of each of program sequences configuring a base program; creating and updating a customization management table; registering the program sequence configuring the base program; registering the correction, executed in the creation of the customized program, every program sequence; registering attribute data of the tenant on the customization management table; determining a location where a multiple deployment program sequence is used; and reconfiguring program sequences of dealing with to tenant individual conditions into a single program.

Thus, the frequency of reference to a tenant identifier and a branch is limited and the degradation of performance can be restrained.

### BRIEF DESCRIPTION OF THE DRAWINGS

FIG. 1 is a block diagram showing an example of a configuration of a program reconfiguration system according to the present invention;

FIG. 2 is a diagram showing a base program example in the present invention;

FIG. 3 is a diagram showing an example of a customization management table in a customization management table control section in the present invention;

FIG. 4 is a flow chart showing an operation of a program reconfiguration system according to the present invention;

FIG. 5 is a flow chart showing an operation of a program sequence calculating section in the present invention;

FIG. 6 is a flow chart showing another example of the operation of the program sequence calculating section in present invention;

FIG. 7 is a diagram showing an example of a customized program in the present invention;

FIG. 8 is a diagram showing an example of the customized program in the present invention;

FIG. 9 is a diagram showing an example of the customized program in the present invention; and

FIG. 10 is a diagram showing an example of a program reconfigured from customized programs in the present invention.

### DESCRIPTION OF EMBODIMENTS

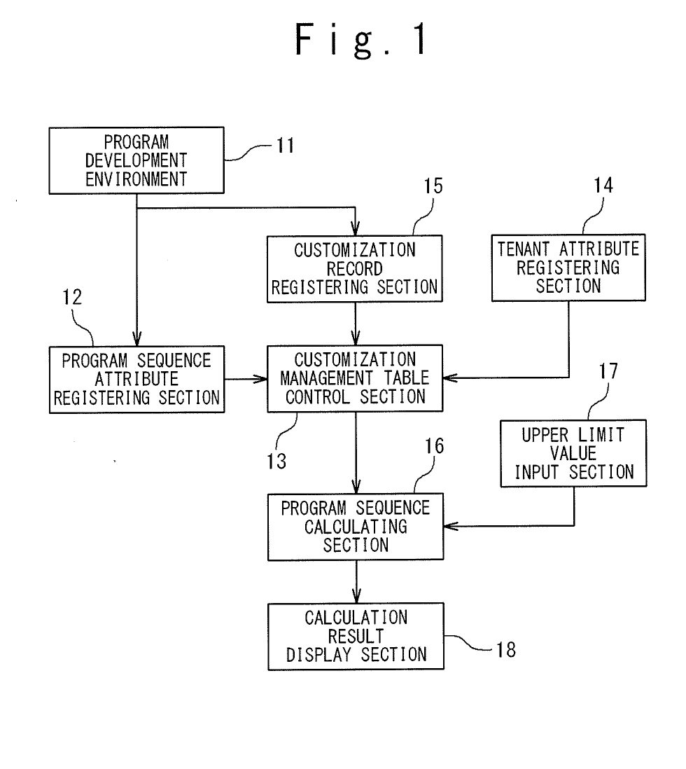

Hereinafter, a program reconfiguration system of the present invention will be described with reference to the attached drawings. Referring to FIG. 1, the program reconfiguration system of the present invention is provided with a program development environment (a program developing section) 11, a program sequence attribute registering section 12, a customization management table control section 13, a tenant attribute registering section 14, a customization record registering section 15, a program sequence calculating section 16, an upper limit value input section 17, and a calculation result display section (a calculation result output section) 18.

The program development environment 11 is a tool for creating a program. The program development environment 11 is used to create a base program and a customized program.

The program sequence attribute registering section 12 registers a program sequence configuring the base program on the customization management table control section 13.

The customization management table control section 13 carries out an operation such as creation and update of a customization management table. For example, the customization management table control section 13 registers a correction record of dealing with a tenant individual condition on the customization management table every program sequence configuring the base program.

The tenant attribute registering section 14 registers attribute data of a tenant on the customization management table.

The customization record registering section 15 registers the contents of the correction every program sequence on the customization management table in case of the creation of a customized program.

The program sequence calculating section 16 determines a location, where a multiple deployment program sequence is used, based on an upper limit value of the number of program sequences to be multiple-deployed, and determines tenants to be accommodated in the multiple deployment program sequence.

The upper limit value input section 17 inputs the upper limit value of the number of program sequences to be multiple-deployed according to an operation of a user, set data and so on.

The calculation result display section 18 outputs a result outputted from the program sequence calculating section 16. For example, the calculation result display section 18 displays the result outputted from the program sequence calculating section 16 on the screen of a display on the side of the user.

### (Exemplification of Hardware Resources)

As an example of the program reconfiguration system, computers such as a PC (a personal computer), a thin client terminal/server, a work station, a main frame, and a supercomputer are exemplified. Also, in addition to the computer itself, it may be a relay device and a peripheral device, an extension board which is mounted on the computer, and a virtual machine (VM) environment built-up on the computer. However, actually, it is not limited to these examples.

The program development environment 11, the program sequence attribute registering section 12, the customization management table control section 13, the tenant attribute registering section 14, the customization record registering section 15, and the program sequence calculating section 16, and the upper limit value input section 17 are realized by hardware resources such as a processor driven by a program, software resources which drive the hardware resources to execute desirable processing, and a memory for storing the software resources and various data.

As an example of the above-mentioned hardware resources, a CPU (Central Processing Unit), a microprocessor, a microcontroller, or a semiconductor integrated circuit (IC) which has a function for exclusive use are exemplified. However, actually, it is not limited to these examples.

As an example of the above-mentioned memory, a RAM (Random Access Memory), a ROM (Read Only Memory), semiconductor memory devices such as EEPROM (Electrically Erasable and Programmable Read Only Memory) and a flash memory, auxiliary memory units such as HDD (Hard Disk Drive) and SSD (Solid State Drive), or a removable disk and a storage medium such as a DVD (Digital Versatile Disk) and SD memory card (Secure Digital memory card) and so on are exemplified. Also, in addition to the storage units which are provided in a computer main body and so on, the memory may be a storage unit installed in a peripheral unit (external HDD and so on) and an external server (a storage server and so on), or it may be NAS (Network Attached Storage) and so on. However, actually, it is not limited to these examples.

Here, when the program sequence attribute registering section 12, the tenant attribute registering section 14, the customization record registering section 15, and the upper limit value input section 17 respond to the registration and input of data from outside, an interface for acquiring data from an external input device or a storage unit, a drive unit which drives the storage medium for read or write, or a network adapter of NIC (Network Interface Card) and so on, an antenna, and a communication port and so on are exemplified as an example of the hardware resources corresponding to the data input function. It should be noted that as an example of the input unit, a keyboard, a keypad, a keypad on a screen, touch panel, a tablet and so on are exemplified. However, actually, it is not limited to these examples.

As an example of the calculation result display section 18, an interface for outputting data to a display device and a storage unit, a drive unit which drives a storage medium for read and write, or a network adapters such as an NIC and so on, an antenna, a communication port are exemplified. It should be noted that as an example of the display unit, an LCD (a liquid crystal display), a PDP (a plasma display), an organic EL display (organic electroluminescence display), or a printer which prints contents on a paper sheet and so on are exemplified. However, actually, it is not limited to these examples.

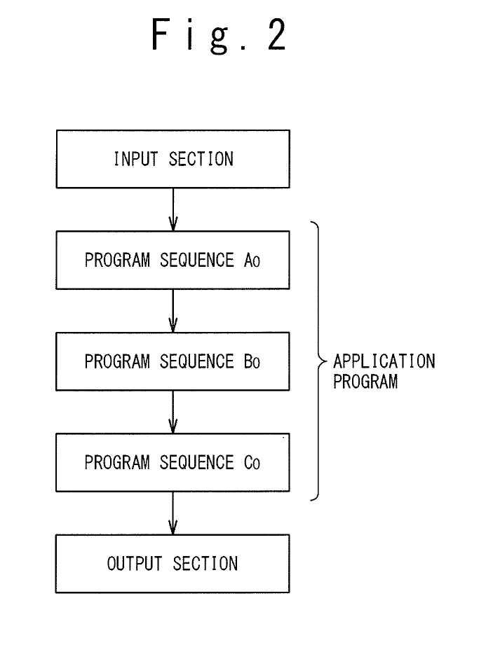

FIG. 2 is a diagram showing an example of the base program. In this example of the base program, an application program is configured of three program sequences A0, B0, and C0. The application program needs to be corrected according to the tenant individual conditions. The input section and the output section indicate common parts to all the program sequences. For example, a program sequence which contains an input/output function is considered as the input section and the output section.

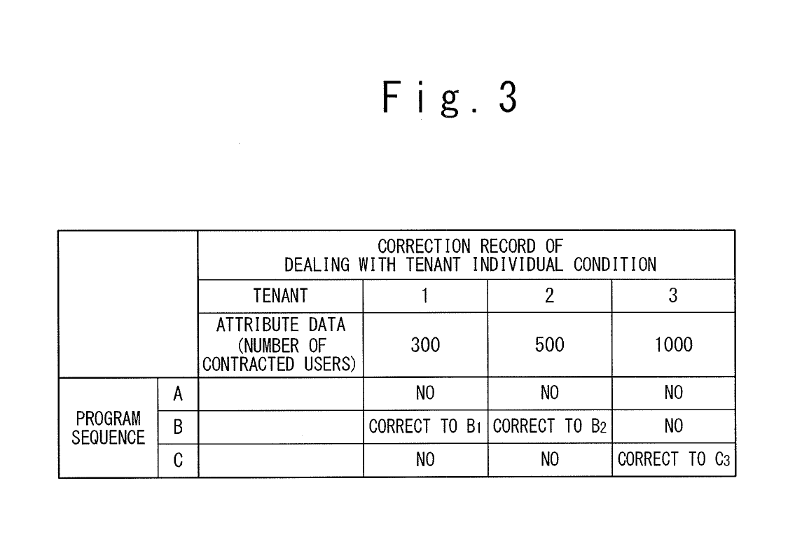

FIG. 3 is a diagram showing an example of the customization management table of customization management table control section 13. In the customization management table, the attribute data of a tenant (the number of contract users for the tenant in this example) is registered in addition to a correction record of dealing with the tenant individual condition every program sequence of the base program. The records such as “no correction” or “correction to the program sequence B1” are registered as the correction records. The correction record is added every time a new tenant is acquired and the tenant individual condition is dealt with.

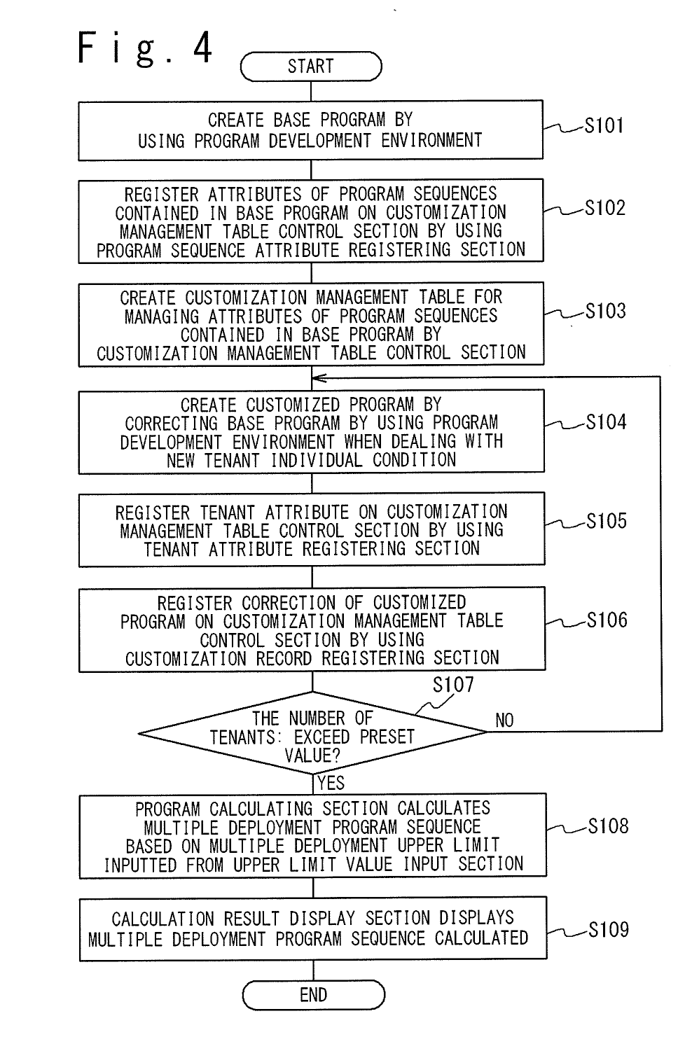

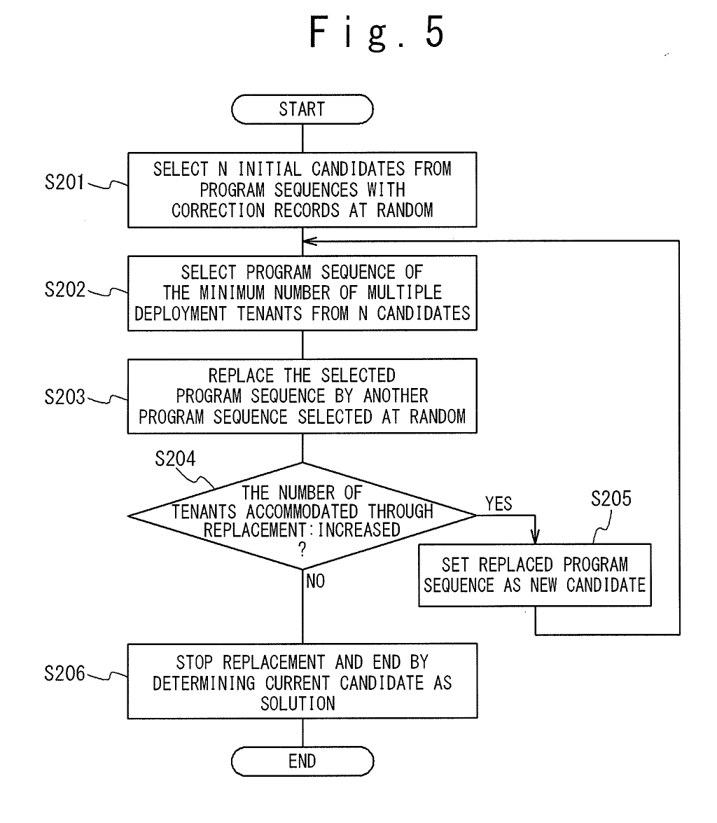

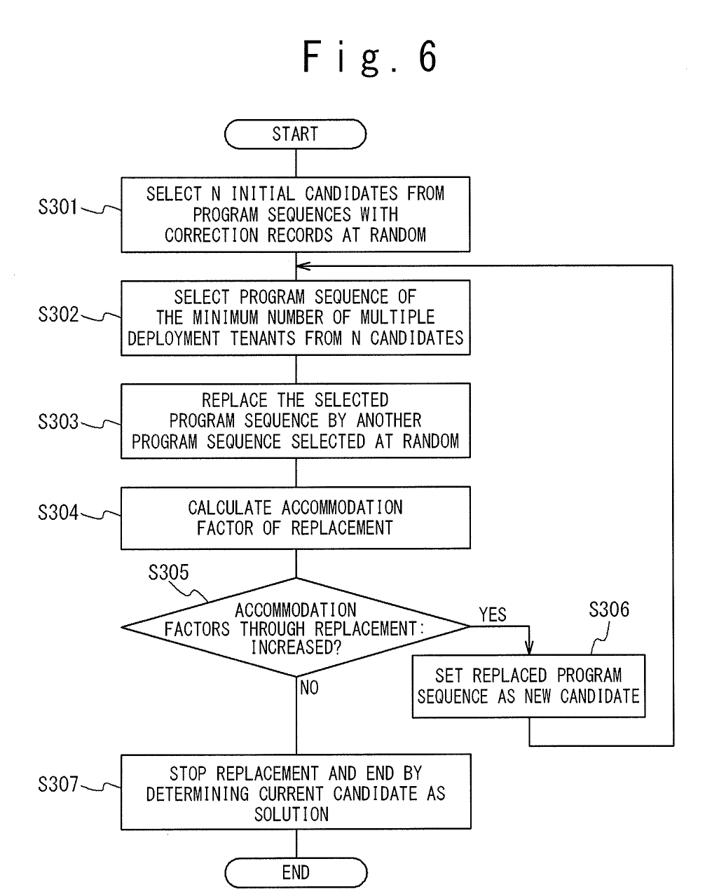

Next, referring to a flow chart of FIG. 4, FIG. 5, and FIG. 6, an operation of the whole embodiment will be described in detail.

FIG. 4 is a flow chart showing the operation of the program reconfiguration system of the present invention.

### (1) Step S101

First, the program development environment 11 creates the base program according to an operation of the user and input data.

### (2) Step S102

The program sequence attribute registering section 12 registers the attributes of program sequences contained in the base program on the customization management table control section 13. Here, it is supposed that the program sequence attribute registering section 12 registers a list of program sequences simply.

### (3) Step S103

The customization management table control section 13 creates the customization management table which manages the attributes of the program sequences contained in the base program.

### (4) Step S104

Next, the program development environment 11 acquires a new tenant, and creates the customized program by correcting the base program when dealing with the tenant individual condition. The program development environment 11 replaces the program sequences of the base program with other program sequences through the correction of the base program. This replacement is different every individual condition.

### (5) Step S105

The tenant attribute registering section 14 registers the attribute of the new tenant on the customization management table control section 13. Here, the tenant attribute registering section 14 registers the number of contract users on the tenant on the customization management table control section 13 as the attribute. It should be noted that the tenant attribute registering section 14 may cooperate with the program development environment 11 to automatically register the attribute of the new tenant on the customization management table control section 13 when the customized program is created.

### (6) Step S106

The customization record registering section 15 registers correction contents to the base program in the creation of the customized program on the customization management table control section 13. Here, the customization record registering section 15 registers which of the program sequences of the base program is replaced on the customization management table. It should be noted that the customization record registering section 15 may cooperate with the program development environment 11 and the tenant attribute registering section 14 to automatically register correction contents on the customization management table control section 13 when the customized program is created or the attribute of the new tenant is registered.

### (7) Step S107

The customization management table control section 13 determines whether or not the number of tenants registered on the customization management table exceeds a preset value. At this time, the customization management table control section 13 waits for the acquisition of a new tenant when the number of tenants registered on the customization management table does not exceed the preset value. When the new tenant is acquired, the operation of dealing with the tenant individual condition is repeated (returns to step S104). On the other hand, when the number of tenants registered on the customization management table exceeds the preset value, the customization management table control section 13 notifies the exceeding to the program calculating section 16.

### (8) Step S108

The program calculating section 16 calculates a program sequence to be multiple-deployed and tenants accommodated in the program sequence based on an upper limit value of the multiple deployment program sequence supplied from the upper limit value input section 17. Then, the program calculating section 16 outputs the calculated multiple deployment program sequence to the calculation result display section 18.

### (9) Step S109

The calculation result display section 18 outputs the calculated multiple deployment program sequence. For example, the calculation result display section 18 displays the program sequence on the screen of a display on the side of the user.

FIG. 5 is a flow chart showing an operation of the program sequence calculating section 16 in the present invention. That is, FIG. 5 shows the details of the step S108 of FIG. 4.

### (1) Step S201

First, the program sequence calculating section 16 selects program sequences as N initial candidates randomly from among the program sequences with correction records in the customization management table. Here, N is equal to the upper limit value of the multiple deployment program sequences supplied from the upper limit value input section 17.

### (2) Step S202

Next, the program sequence calculating section 16 selects one program sequence to be multiple-deployed having the minimum number of tenants, from among the program sequences as the N initial candidates.

### (3) Step S203

The program sequence calculating section 16 replaces the selected program sequence (the program sequence having the minimum number of tenants) by another program sequence selected randomly.

### (4) Step S204

The program sequence calculating section 16 determines whether or not the number of tenants possible to accommodate increases through this replacement.

### (5) Step S205

The program sequence calculating section 16 sets the other program sequence to a new candidate if the number of tenants possible to accommodate increases. The program sequence calculating section 16 returns to the control flow in which the program sequence to be multiple-deployed having the minimum number of tenants is replaced, to repeat the above procedure.

### (6) Step S206

The program sequence calculating section 16 stops the replacement if the number of tenants possible to accommodate does not increase. The current candidate is set as a solution of the program sequence to be multiple-deployed, and the control flow ends. At the same time, the program sequence calculating section 16 outputs the tenants possible to accommodate.

FIG. 6 is a flow chart showing another operation of the program sequence calculating section 16. That is, the details of the step S108 of FIG. 4 are shown by using another example different from FIG. 5.

In the flow chart of FIG. 6, a procedure which calculates an accommodation factor about the replacement is added to the flow chart of FIG. 5. The accommodation factor is a value which is calculated from the tenant attribute registered from the tenant attribute registering section 14.

In FIG. 5, whether or not a new candidate is set is determined based on the number of tenants possible to accommodate. However, supposing that a total number of contract users possible to accommodate is an accommodation factor, whether or not a new candidate is set is determined based on whether or not the total number of contract users possible to accommodate increases. Also, a total of contract years with the tenant and a total amount of contract with the tenant can be used for the accommodation factor. In this case, these values are registered previously by the tenant attribute registering section 14 as the tenant attribute. The other procedure is identical with FIG. 5.

### (1) Step S301

First, the program sequence calculating section 16 selects N initial candidates randomly from among the program sequences with correction records by the customization management table. Here, N is equal to an upper limit value of the multiple deployment program sequence supplied from the upper limit value input section 17.

### (2) Step S302

Next, the program sequence calculating section 16 selects one program sequence to be multiple-deployed having the minimum number of tenants from the N candidates.

### (3) Step S303

The program sequence calculating section 16 replaces the selected program sequences by another program sequence selected randomly.

### (4) Step S304

The program sequence calculating section 16 calculates an accommodation factor about the replacement.

### (5) Step S305

The program sequence calculating section 16 determines whether or not the replacement increases the accommodation factor.

### (6) Step S306

The program sequence calculating section 16 sets the other program sequence to a new candidate if the accommodation factor increases. The program sequence calculating section 16 returns to a procedure in which the program sequence to be multiple-deployed having the minimum number of tenants is replaced, and repeats the above-mentioned procedure.

### (7) Step S307

The program sequence calculating section 16 stops the replacement if the accommodation factor does not increase, and the control flow ends after the current candidate is set as a solution of the program sequence to be multiple-deployed. At the same time, the program sequence calculating section 16 outputs the tenants accommodated by this solution.

It should be noted that the program sequence calculating section 16 may execute a combination of the operation in the flow chart of FIG. 5 and the operation in the flow chart of FIG. 6. For example, the program sequence calculating section 16 advances to the step S304 of FIG. 6 if the number of tenants possible to accommodate does not increase at the step S206 of FIG. 5, to calculate the accommodation factor about this replacement, and to execute processing of a step S305 of FIG. 6 and the subsequent. Or, the user allows the program sequence calculating section 16 to select one of the operation in the flow chart of FIG. 5 and the operation in the flow chart of FIG. 6.

In this embodiment, the program sequences are reconfigured into a single program which can accommodate as many tenants as possible while locations where multiple deployment program sequences are used are suppressed within a predetermined number. For this purpose, the frequency of the reference to the tenant identifier and the branch is limited and the reduction of performance can be restrained.

### Implementation Example

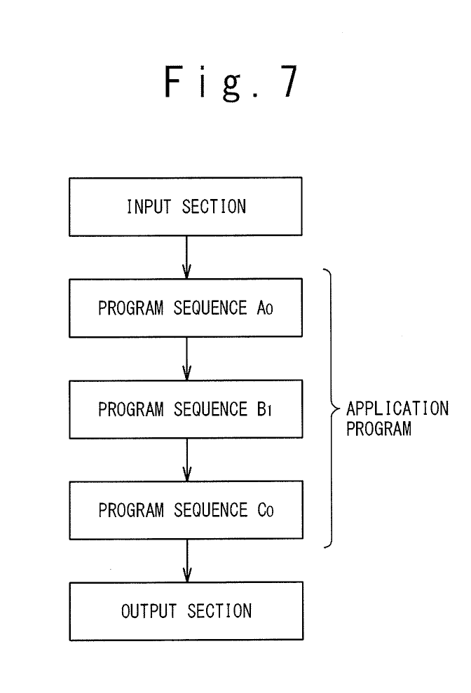

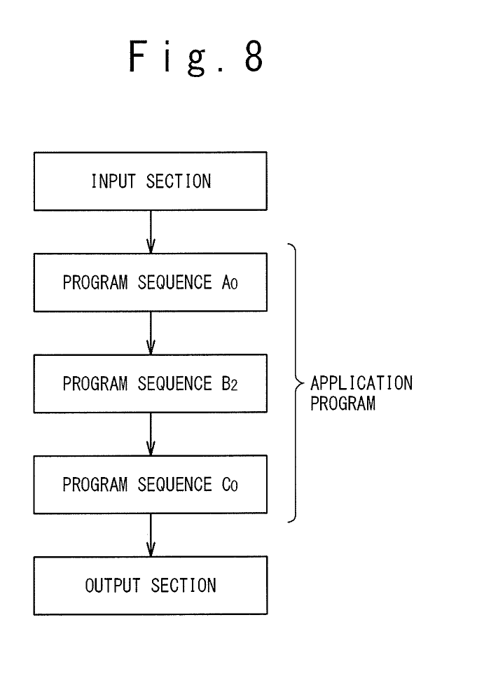

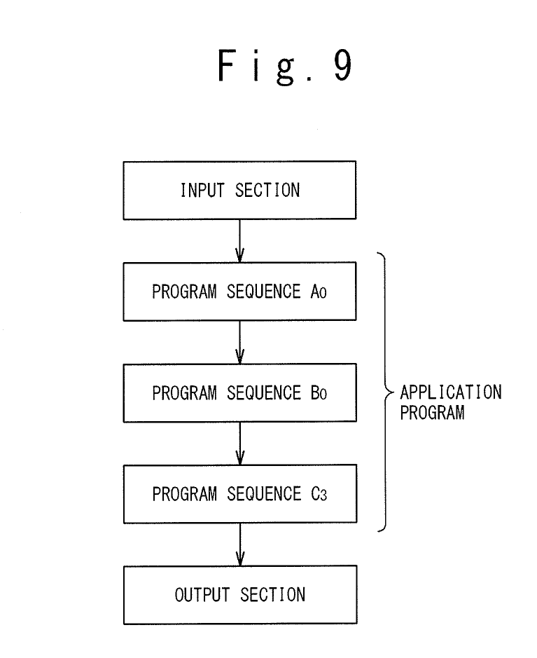

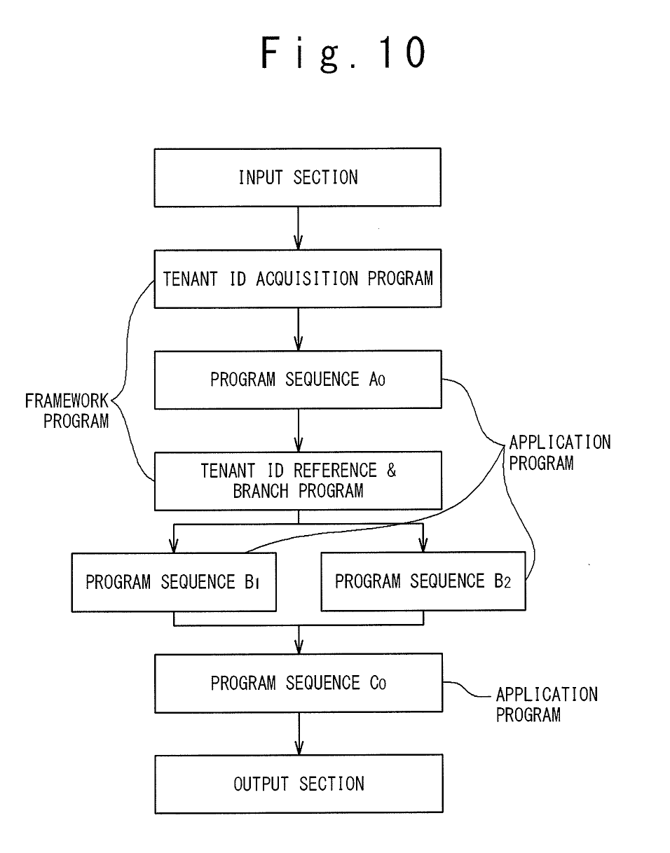

Next, the implementation examples of the present invention will be described in detail with reference to FIG. 7, FIG. 8, FIG. 9, and FIG. 10. Here, like the flow chart of FIG. 5, a case in which whether or not a new candidate is set is determined based on the number of tenants possible to accommodate, will be described.

An example corresponding to three tenant individual conditions will be described based on the base program shown in FIG. 2. Referring to FIG. 3, the tenant 1 has 300 as the number of the contract users. FIG. 2 shows that the program sequence B of the base program has been corrected to the program sequence B₁ by dealing with the tenant individual condition 1. The base program shown in FIG. 3 is corrected to a customized program shown in FIG. 7. The tenant 1 uses the customized program shown in FIG. 7.

The tenant 2 has 500 as the number of the contract users. FIG. 3 shows that the program sequence B of the base program is corrected to the program sequence B₂ by dealing with the tenant individual condition 2. The base program shown in FIG. 2 is corrected to the customized program shown in FIG. 8. The tenant 1 uses the customized program shown in FIG. 8.

The tenant 3 has 1000 as the number of the contract users. FIG. 3 shows that the program sequence C of the base program is corrected to the program sequence C₃ by dealing with the tenant individual condition 3. The base program shown in FIG. 2 is corrected to the customized program shown in FIG. 9. The tenant 1 uses the customized program shown in this FIG. 9.

An operation of the program sequence calculating section 16 will be described when these three customized programs are reconfigured into a single program.

It is supposed that the upper limit value of the multiple deployment program sequence inputted from the upper limit value input section 17 is “N=1” (step S108 of FIG. 4). Referring to FIG. 3, the number of tenants to be accommodated in the program sequence A is 0. The number of tenants to be accommodated in the program sequence B is 2 (the tenant 1 and the tenant 2 are accommodated). The number of tenants to be accommodated in the program sequence C is 1 (the tenant 3 is accommodated). The phrase “possible to accommodate” means that the program sequences corrected to deal with the tenant individual condition forms a partial set of the program sequences as candidates.

The program sequence calculating section 16 selects one initial candidate from among the program sequences with the correction records in the customization management table randomly (step S201 of FIG. 5). The initial candidate is referred to as the program sequence C. Because the candidate is only one, the program sequence with the minimum number of tenants to be accommodated is the program sequence C (step S202 of FIG. 5).

The program sequence calculating section 16 replaces the program sequence C by another program sequence selected randomly (step S203 of FIG. 5). Here, it is supposed that the program sequence calculating section 16 replaces the program sequence C by the program sequence B. The number of tenants possible to accommodate increases from 1 to 2 through this replacement (step S204 of FIG. 5). Therefore, the program sequence calculating section 16 sets the program sequence B to a new candidate (step S205 of FIG. 5).

Again, the program sequence calculating section 16 replaces the program sequence B by another program sequence selected randomly (step S203 of FIG. 5). Here, it is supposed that the program sequence calculating section 16 replaces by the program sequence A. The number of tenants possible to accommodate, decreases from 2 to 0 through this replacement (step S204 of FIG. 5). Therefore, the program sequence calculating section 16 stops the replacement, determines the present candidate B as a solution of the program sequence to be multiple-deployed and ends (step S206 of FIG. 5). At the same time, the program sequence calculating section 16 outputs the tenant 1 and the tenant 2 which are possible to accommodate based on this solution, to the calculation result display section 18.

The calculation result display section 18 outputs the multiple deployment program sequence B and the tenant 1 and the tenant 2 which are possible to accommodate through the multiple deployment. For example, they are displayed on the screen of the display unit on the side of the user (step S109 of FIG. 4).

FIG. 10 shows a program reconfigured based on this result. The concerned program is supposed to be executed by a hardware unit such as a CPU. By using the aspect-oriented programming and so on, a tenant ID (identifier) acquisition program is automatically inserted at the time of execution as a framework program immediately before the program sequence A of the application program which is executed first. The tenant ID (identifier) acquisition program is a program to refer to an IP address of a transmission source of the communication and so on and to determine and preserve the tenant ID (identifier).

A tenant ID (identifier) reference and branch program is automatically inserted at the time of execution as the framework program immediately before the multiple deployment program sequence B. The tenant ID (identifier) reference and branch program is a program which refers to the tenant ID (identifier) preserved by the tenant ID (identifier) acquisition program and determines which of the multiple deployment program sequences should be called. Thus, the program sequence B₁ is executed in case of the tenant 1 and the program sequence B₂ is executed in case of the tenant 2.

In a system which provides on-line service to many users (tenant companies and end users) by using an existing application, the present invention can be applied to a field in which refactoring of the existing application is supported so as to have a format by which it is easy to introduce a user individual condition (data which is different every user and processing which is different every user).

As mentioned above, the program reconfiguration system of the present invention is a system to reconfigure program sequences corresponding to the tenant individual conditions into a single program.

The program reconfiguration system of the present invention is provided with a program development environment, a customization management table control section, a program sequence attribute registering section, a customization record registering section, a tenant attribute registering section, and a program sequence calculating section.

The program development environment corrects a part of the program sequence configuring the base program to create a customized program. The customization management table control section creates and updates a customization management table. The program sequence attribute registering section registers program sequences of the base program. The customization record registering section registers the correction executed in case of creation of the customized program every program sequence. The tenant attribute registering section registers attribute data of the tenant on the customization management table. The program sequence calculating section determines a use location of the multiple deployment program sequence.

The customization management table includes a correction record of dealing with the tenant individual condition every program sequence of the base program.

In the first technique, the customization management table contains the number of contract users every tenant as the tenant attribute.

In the second technique, the customization management table contains the number of contract years every tenant as the tenant attribute.

In the third technique, the customization management table contains an amount of contract every tenant as the tenant attribute.

The program sequence calculating section determines the multiple deployment program sequence while newly setting a candidate of the multiple deployment program sequence, based on the upper limit value of the number of program sequences to be multiple-deployed, such that the number of tenants possible to accommodate through the multiple deployment of a program sequence increases (when the number of tenants possible to accommodate should be increase).

The program sequence calculating section determines the multiple deployment program sequence while newly setting a candidate of the multiple deployment program sequence, based on the upper limit value of the number of program sequences to be multiple-deployed, such that the accommodation factor through the multiple deployment of a program sequence increases (when the accommodation factor should be increase).

In the first technique, the accommodation factor has a total number of contract users.

In the second technique, the accommodation factor is a total number of contract years.

In the third technique, the accommodation factor is a total of amounts of contract.

The program reconfiguration system of the present invention provides on-line service to many users (tenant companies and end users) by using an existing application.

In an information system which creates and executes a customized program through correction of an application program to deal with the user individual condition (processing different every user, data different every user), the present invention is possible to support to reconfigure the customized programs of dealing with the tenant individual condition into a single program as far as possible.

It should be noted that because a program often becomes redundant through the design change and the correction of problems as the development of the program proceeds, the reconfiguration is one form of refactoring which eliminates a redundant portion of the program without changing the logic of the program, and modifies the program to have the high serviceability and extendibility.

In the above, the embodiments of the present invention have been described in detail. However, the present invention is not limited to the above-mentioned embodiments. A modification of a range which is not departing from the present invention is contained in the present invention.

It should be noted that this patent application claims a priority on convention based on Japan Patent Application No. JP 2009-161668. The disclosure thereof is incorporated herein by reference.

1. A program reconfiguration system which reconfigures program sequences of dealing with tenant individual conditions into a single program, comprising:
a program development section configured to correct a part of a program sequence configuring a base program to create a customized program;
a customization management table control section configured to create and update a customization management table;
a program sequence attribute registering section configured to register said program sequences configuring said base program;
a customization record registering section configured to register correction performed in case of the creation of the customized program every program sequence;
a tenant attribute registering section configured to register attribute data of a tenant on said customization management table; and
a program sequence calculating section configured to determine a use location of a multiple deployment program sequence.

2. The program reconfiguration system according to claim 1, wherein said customization management table control section registers a record of the correction of dealing with tenant individual condition of each of the program sequences configuring said base program on said customization management table.

3. The program reconfiguration system according to claim 1, wherein said tenant attribute registering section registers any of:
the number of contract users every tenant,
the number of contract years every tenant, and
an amount of contract every tenant,
on said customization management table as attribute data of the tenant.

4. The program reconfiguration system according to claim 1, wherein when the number of tenants possible to accommodate should be increased through multiple deployment of the program sequence, said program sequence calculating section newly sets a candidate of the multiple deployment program sequence to determine the multiple deployment program sequence, based on an upper limit value of the number of multiple deployment program sequences.

5. The program reconfiguration system according to claim 1, wherein when an accommodation factor should be increased through multiple deployment of the program sequence, said program sequence calculating section newly sets a candidate of the multiple deployment program sequence to determine the multiple deployment program sequence, based on an upper limit value of the number of multiple deployment program sequences.

6. The program reconfiguration system according to claim 5, wherein said program sequence calculating section handles as said accommodation factor, any of:
a total number of contract users;
a total number of contract years; and
a total of amounts of contract.

7. A program reconfiguration method which is executed by a computer, comprising:
creating a customized program by correcting a part of each of program sequences configuring a base program;
creating and updating a customization management table;
registering said program sequences configuring said base program;
registering the correction executed in case of creation of said customized program every program sequence;
registering attribute data of a tenant on said customization management table;
determining a use location of a multiple deployment program sequence; and
reconfiguring said program sequences of dealing with a tenant individual condition into a single program.

8. The program reconfiguration method according to claim 7, further comprising:
registering a record of the correction of dealing with the tenant individual condition for each of said program sequences configuring said base program on said customization management table.

9. The program reconfiguration method according to claim 7, further comprising:
registering on said customization management table as attribute data of the tenant, any of:
the number of contract users every tenant;
the number of contract years every tenant; and
the amount of contract every tenant.

10. The program reconfiguration method according to claim 7, further comprising:
newly setting a candidate of the multiple deployment program sequence and determining the multiple deployment program sequence, based on an upper limit value of the number of multiple deployment program sequences, when the number of tenants possible to accommodate should be increased through multiple deployment of the program sequence.

11. The program reconfiguration method according to claim 7, further comprising:
newly setting a candidate of the multiple deployment program sequence and determining the multiple deployment program sequence, based on an upper limit value of the number of multiple deployment program sequences, when an accommodation factor should be increased through multiple deployment of the program sequence.

12. The program reconfiguration method according to claim 11, further comprising:
handling as said accommodation factor, any of:
a total number of contract users;
a total number of contract years; and
a total of amounts of contract.
